(19) United States
(12) Patent Application Publication
(10) Pub. No.: US 2008/0053817 A1
(43) Pub. Date: Mar. 6, 2008

(54) PLASMA PROCESSING APPARATUS AND PLASMA PROCESSING METHOD

(75) Inventors: Chishio Koshimizu, Nirasaki-shi (JP); Naoki Matsumoto, Amagasaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 11/849,586

(22) Filed: Sep. 4, 2007

Related U.S. Application Data
(60) Provisional application No. 60/849,460, filed on Oct. 5, 2006.

(30) Foreign Application Priority Data
Sep. 4, 2006 (JP) 2006-239159

(51) Int. Cl. H05F 3/00; B01J 19/12

(52) U.S. Cl. 204/164; 422/186.04

(57) ABSTRACT

A plasma processing apparatus includes a high-frequency power supply applying a high-frequency power to at least any of plural electrodes; a direct-current power supply applying a direct-current voltage to at least any of the plural electrodes; a matching device provided between the electrode to which the high-frequency power is applied and the high-frequency power supply; and a control device controlling the high-frequency power supply such that the high-frequency power applied to the electrode is previously adjusted at a timing when the apply of the direct-current voltage to the electrode by the direct-current power supply is started or terminated, under a state in which the high-frequency power is applied to the electrode by the high-frequency power supply.

### BACKGROUND OF THE INVENTION

1. Field of the Invention

The present invention relates to a plasma processing apparatus having one or more electrodes in a processing chamber, generating plasma in the processing chamber by supplying at least any of the electrodes with a high-frequency power, to process a substrate, and a plasma processing method.

2. Description of the Related Art

For example, a process using plasma is widely used in a substrate processing such as an etching, a film formation in a manufacturing process of a semiconductor device, a liquid crystal display device, and so on.

The plasma processing is usually performed in a plasma processing apparatus. For example, electrodes facing each other vertically are provided in a processing chamber in this plasma processing apparatus, in which plasma is generated by supplying either one of or both of these electrodes with a high-frequency power, to perform the plasma processing of a substrate.

In recent years, a plasma processing technique has been developed in which a direct-current voltage is applied to an electrode in a processing chamber from a direct-current power supply for various purposes in addition to apply a high-frequency power to the electrode in the processing chamber from a high-frequency power supply via a matching device. There is disclosed a plasma processing technique in which a direct-current voltage is applied to an upper electrode before a high-frequency power is applied to each of the upper electrode and a lower electrode provided to face in a processing chamber to facilitate an ignition of plasma, in Japanese Patent Application Laid-open No. 2003-124198.

Besides, there is disclosed a plasma processing technique making plasma uniform by thickening a plasma sheath by applying a direct-current voltage to an upper electrode and increasing a self-bias voltage in addition to apply a high-frequency power to each of the upper electrode and a lower electrode provided to face in a processing chamber, in Japanese Patent Application Laid-open No. 2000-323460.

### SUMMARY OF THE INVENTION

However, an influence exerted by a start or a termination of an apply of a direct-current voltage to an electrode on a high-frequency power applied to the same or the other electrode is not considered in the above-stated plasma processing techniques described in Japanese Patent Application Laid-open No. 2003-124198, Japanese Patent Application Laid-open No. 2000-323460. Actually, when the high-frequency power is applied to the electrode by the high-frequency power supply and the direct-current voltage is applied to the same or the other electrode, impedance of plasma generated by the high-frequency power changes suddenly, and large reflection energy is returned to the high-frequency power supply. A reflection protection circuit of the high-frequency power supply is activated under the state as stated above, and an output of the high-frequency power is lowered. Consequently, controls of an apply operation of the high-frequency power by the high-frequency power supply and a matching operation of a matching device become very difficult. As a result, hunting may occur in the plasma in the processing chamber, or disappeared at worst, and it becomes impossible to perform a plasma processing of a substrate stably. Further, there is a possibility that the plasma becomes nonuniform, and charge up damage may be given to the substrate.

The present invention is made in consideration of the above-stated problems, and an object thereof is to provide a plasma processing apparatus and a plasma processing method capable of stabilizing plasma in a processing chamber and performing a plasma processing of a substrate stably when the substrate is processed by applying a high-frequency power and a direct-current voltage to the same or the other electrode.

To solve the above-stated problem, according to the present invention, there is provided a plasma processing apparatus having one or more electrodes in a processing chamber, generating plasma in the processing chamber by supplying at least any of the electrodes with a high-frequency power to process a substrate, including: a high-frequency power supply applying the high-frequency power to at least any of the one or more electrodes; a direct-current power supply applying a direct-current voltage to at least any of the one or more electrodes; a matching device provided between the electrode to which the high-frequency power is applied and the high-frequency power supply; and a control device controlling the high-frequency power supply such that the high-frequency power applied to the electrode is previously adjusted at a timing when the apply of the direct-current voltage to the electrode by the direct-current power supply is started or terminated, under a state in which the high-frequency power is applied to the electrode by the high-frequency power supply.

In the above-described plasma processing apparatus, the high-frequency power applied to the electrode may be adjusted to be lowered when the high-frequency power applied to the electrode by the high-frequency power supply is previously adjusted.

In the above-described plasma processing apparatus, the control device may control the matching device such that a matching operation is previously adjusted at a timing when the apply of the direct-current voltage to the electrode by the direct-current power supply is started or terminated under the state in which the high-frequency power is applied to the electrode by the high-frequency power supply.

In the above-described plasma processing apparatus, the matching operation of the matching device may be adjusted based on a prediction of a change of the plasma in the processing chamber when the matching operation of the matching device is previously adjusted.

In the above-described plasma processing apparatus, the control device may previously have information of a timing when the apply of the direct-current voltage to the electrode by the direct-current power supply is started or terminated, or information of the direct-current voltage applied to the electrode by the direct-current power supply.

In the above-described plasma processing apparatus, the control device may control the direct-current power supply such that the apply of the direct-current voltage to the electrode is started or terminated.

In the above-described plasma processing apparatus, the control device may control the matching device such that the matching operation is to be performed while considering an influence on the plasma caused by the direct-current voltage applied to the electrode when the apply of the high-frequency power to the electrode by the high-frequency power supply is started or terminated under a state in which the direct-current voltage is applied to the electrode by the direct-current power supply.

Further, according to the present invention, there is provided a plasma processing method, generating plasma in a processing chamber by supplying at lest any of one or more electrodes provided in the processing chamber with a high-frequency power to process a substrate, including: applying the high-frequency power to at least any of the one or more electrodes; applying a direct-current voltage to at least any of the one or more electrodes; and previously adjusting the high-frequency power applied to the electrode at a timing when the apply of the direct-current voltage is started or terminated under a state in which the high-frequency power is applied to the electrode.

In the above-described plasma processing method, the high-frequency power applied to the electrode may be adjusted to be lowered when the high-frequency power applied to the electrode is previously adjusted.

In the above-described plasma processing method, the apply of the high-frequency power to the electrode may be performed while matching impedance between the plasma in the processing chamber and the high-frequency power supply supplying the high-frequency power, and the matching of the impedance may be previously adjusted at a timing when the apply of the direct-current voltage to the electrode is started or terminated under the state in which the high-frequency power is applied to the electrode.

In the above-described plasma processing method, the matching of the impedance may be adjusted based on a prediction of a change of the plasma in the processing chamber when the matching of the impedance is previously adjusted.

In the above-described plasma processing method, the matching of the impedance may be performed while considering an influence on the plasma caused by the direct-current voltage applied to the electrode when the apply of the high-frequency power to the electrode is started or terminated under a state in which the direct-current voltage is applied to the electrode.

According to the present invention, when the high-frequency power is applied to the electrode and the apply of the direct-current voltage to the same electrode or the other electrode is started or terminated, it becomes possible to prevent that the apply operation of the high-frequency power supply and the matching operation of the matching device become unstable by previously adjusting the high-frequency power applied to the electrode while considering the influence caused by the apply operation of the direct-current voltage. Accordingly, it becomes possible to stabilize the plasma in the processing chamber, and to perform the plasma processing of the substrate stably.

### BRIEF DESCRIPTION OF THE DRAWINGS

FIG. 1 is a configuration diagram of a plasma etching apparatus 1 as a plasma processing apparatus according to a first embodiment of the present invention;

FIG. 2 is a timing chart showing an apply operation of a direct-current power supply 22, an apply operation of a high-frequency power supply 16, and a matching operation of a matching device 15 controlled by a stabilization control device 25 at the time of plasma etching;

FIG. 3 is a timing chart showing an apply operation of a direct-current power supply 22, an apply operation of a high-frequency power supply 16, and a matching operation of a matching device 15 controlled by a stabilization control device 25 at the time of plasma etching in a second embodiment of the present invention; and

FIG. 4 is a configuration diagram of a plasma etching apparatus 1 as a plasma processing apparatus according to a third embodiment of the present invention.

### DETAILED DESCRIPTION OF THE INVENTION

Hereinafter, preferred embodiments of the present invention are described with reference to the drawings. Note that in this specification and drawings, elements having substantially the same functions and structures are designated the same reference numerals, and thereby duplicating explanations are not given.

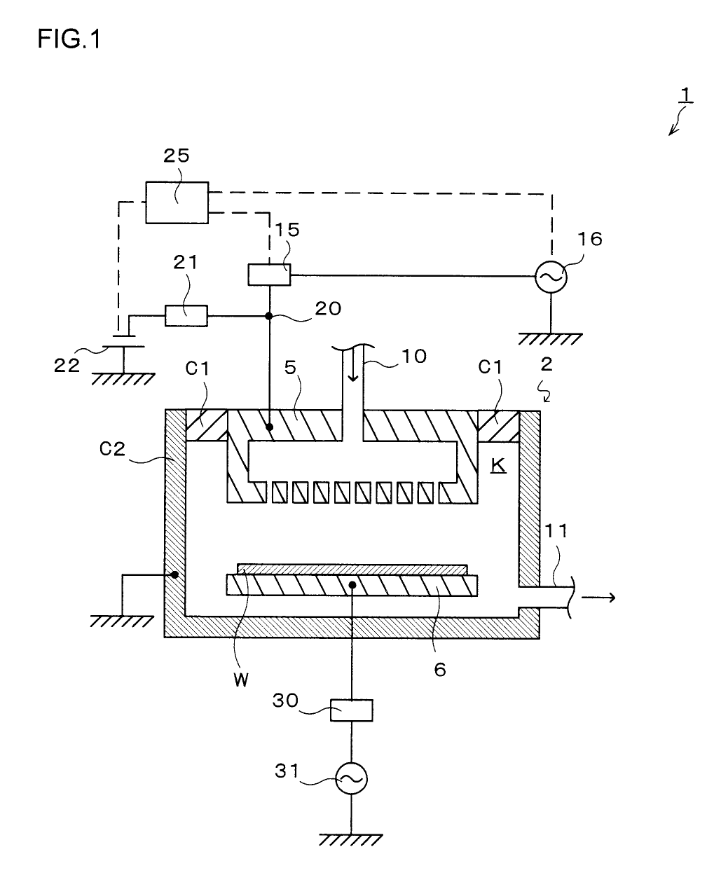

FIG. 1 is a configuration diagram of a plasma etching apparatus 1 as a plasma processing apparatus according to an embodiment of the present invention. As shown in FIG. 1, the plasma etching apparatus 1 has a processing chamber 2 in, for example, a substantially cylindrical shape. Inside the processing chamber 2, a processing space K is formed. A wall portion C2 of the processing chamber 2 is grounded for protection. In the processing chamber 2, an upper electrode 5 and a lower electrode 6 are arranged to face each other. The upper electrode 5 and the lower electrode 6 are both in a substantially disc shape and formed of a conductive material. Between the upper electrode 5 and the wall portion C2, insulators C1 are interposed. The lower electrode 6 combines a role of a mounting table for a substrate W. In the processing space K, processing gas is supplied via a gas supply path 10 and the upper electrode 5 which also has a function as a shower head. Further, the processing gas in the processing space K is exhausted via a gas exhaust path 11.

A high-frequency power supply 16 is electrically connected to the upper electrode 5 via a matching device 15. The high-frequency power supply 16 is capable of applying a high-frequency power having a frequency of, for example, 60 MHz to the upper electrode 5 so as to excite the processing gas in the processing space K into plasma. The matching device 15 can match impedance between the plasma generated in the processing space K and the high-frequency power supply 16.

A direct-current power supply 22 is electrically connected to a connection point 20 between the matching device 15 and the upper electrode 5 via a low pass filter 21, and direct-current voltage can be applied to the upper electrode 5. Incidentally, capacitors (not shown) are provided in series in the matching device 15.

The high-frequency power supply 16, the matching device 15, and the direct-current power supply 22 are connected to a stabilization control device 25. This stabilization control device 25 respectively controls the apply operation of the high-frequency power to the upper electrode 5 by the high-frequency power supply 16, the matching operation of the impedance between the high-frequency power supply 16 and the plasma in the processing space K by the matching device 15, and an apply operation of the direct-current voltage to the upper electrode 5 by the direct-current power supply 22 as stated below, to thereby enable to stabilize the plasma processing of the substrate W.

A high-frequency power supply 31 supplying a high-frequency power having a frequency of, for example, 2 MHz is electrically connected to the lower electrode 6 via a matching device 30. The high-frequency power supply 31 is capable of applying the high-frequency power having the frequency of, for example, 2 MHz to the lower electrode 6 so as to draw ions within the plasma generated in the processing space K into the lower electrode 6. The matching device 30 is capable of matching impedance between the plasma generated in the processing space K and the high-frequency power supply 31.

Next, a plasma etching method for the substrate W as an example of a plasma processing method according to an embodiment of the present invention using the plasma etching apparatus 1 constituted as above, will be explained by using FIG. 1.

At first, the substrate W is carried into the processing chamber 2 and mounted on the lower electrode 6, as shown in FIG. 1. Exhaustion is performed through the exhaust path 11, the inside of the processing chamber 2 is decompressed, and predetermined processing gas is supplied to the processing chamber 2 from the gas supply path 10 via the upper electrode 5.

The high-frequency power having the frequency of 60 MHz for generating plasma is applied to the upper electrode 5 by the high-frequency power supply 16 via the matching device 5. Thus the processing gas in the processing space K is excited into plasma. Next, the high-frequency power having the frequency of 2 MHz is supplied to the lower electrode 6 by the high-frequency power supply 31 via the matching device 30, the ions in the generated plasma are drawn into the substrate W, and thereby a surface film of the substrate W is etched. Further, the direct-current voltage is applied to the upper electrode 5 by the direct-current power supply 22 so as to make the plasma uniform by increasing a self bias voltage VSB of the upper electrode 5. After the etching is performed for predetermined time, supplies of the high-frequency power and the direct-current voltage are stopped, the substrate W is carried out from the processing chamber 2, and a series of plasma etching processes is finished.

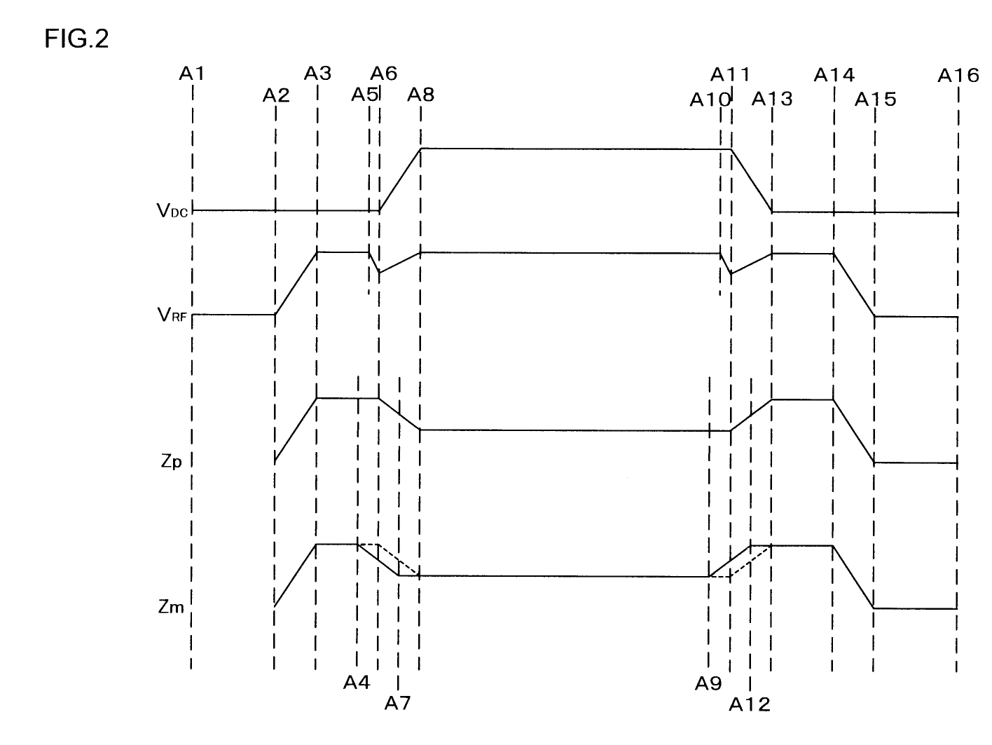

At the time of the above-stated series of plasma etching processes, the apply operation of the direct-current power supply 22, the apply operation of the high-frequency power supply 16, and the matching operation of the matching device 15 are controlled by the stabilization control device 25. FIG. 2 is a timing chart respectively showing the apply operation of the direct-current power supply 22, the apply operation of the high-frequency power supply 16, and the matching operation of the matching device 15 controlled by the stabilization control device 25 at the time of plasma etching. In FIG. 2, a horizontal axis direction shows a time flow, and a vertical axis direction respectively shows changes of a value VDC of the direct-current voltage applied to the upper electrode 5 by the direct-current power supply 22, a voltage value VRF of the high-frequency power applied to the upper electrode 5 by the high-frequency power supply 16, a value Zp of predicted impedance of the plasma in the processing space K, and a value Zm of impedance at the high-frequency power supply 16 side which is matched with actual impedance Z of the plasma by the matching device 15. Incidentally, the value Zp of the predicted impedance of the plasma is a predicted value previously calculated by the stabilization control device 25 controlling the apply operations of the high-frequency power supply 16 and the direct-current power supply 22 before executions of these apply operations. When the value Zp of the predicted impedance of the plasma is calculated, the self bias voltage VSB of the upper electrode 5 may be measured by using a not-shown measurement device, to calculate the value Zp based on the measured value.

In FIG. 2, the direct-current voltage VDC and the voltage VRF show high values in a vertical axis upper direction, and show low values in a vertical axis lower direction. On the other hand, the predicted impedance Zp of the plasma and the impedance Zm of the matching device 15 show low values in the vertical axis upper direction, and show high values in the vertical axis lower direction. Hereinafter, the apply operation of the direct-current power supply 22, the apply operation of the high-frequency power supply 16, and the matching operation of the matching device 15 controlled by the stabilization control device 25 at the time of plasma etching are described by using FIG. 2. Incidentally, the high-frequency power applied to the lower electrode 6 by the high-frequency power supply 31 is not described in detail to simplify the description in the following, but the apply operation to the lower electrode 6 by the high-frequency power supply 31 is performed accordingly in accordance with the apply operation of the voltage VRF to the upper electrode 5 by the high-frequency power supply 16.

At first, in an initial state (time A1 shown in FIG. 2), the high-frequency power from the high-frequency power supply 16 and the direct-current voltage from the direct-current power supply 22 are not supplied to the upper electrode 5. Namely, both values of the voltage VRF applied to the upper electrode 5 by the high-frequency power supply 16 and the direct-current voltage VDC applied to the upper electrode 5 by the direct-current power supply 22 are zero. Consequently, the plasma is not generated in the processing chamber 2 at this time A1, and therefore, the predicted impedance Zp of the plasma is not shown. Besides, the matching device 15 controlling the impedance Zm at the high-frequency power supply 16 side is not activated.

The apply of the voltage VRF to the upper electrode 5 from the high-frequency power supply 16 is started by the control of the stabilization control device 25 (time A2 shown in FIG. 2), and the value of the voltage VRF is increased with a predetermined increase rate. The voltage VRF reaches a predetermined value (time A3 shown in FIG. 2), then the voltage VRF is held at the predetermined value. The plasma is generated and increased from the processing gas by the apply of the voltage VRF in the processing chamber 2, and therefore, the calculated predicted impedance Zp of the plasma is lowered. Besides, when the voltage VRF becomes constant, the predicted impedance Zp also becomes constant. The matching device 15 matches the impedance Zm at the high-frequency power supply 16 side based on the actual impedance Z of the plasma, and therefore, the impedance Zm shows a substantially similar behavior with the predicted impedance Zp.

After the plasma in the processing chamber 2 becomes in a stable state, the apply of the direct-current voltage VDC to the upper electrode 5 by the direct-current power supply 22 is started by the control of the stabilization control device 25 (time A6 shown in FIG. 2), and the value of the direct-current voltage VDC is increased with a predetermined increase rate. The direct-current voltage VDC reaches a predetermined value (time A8 shown in FIG. 2), then the voltage VDC is held at the predetermined value. This predetermined value may be, for example, a value in which the self bias voltage VSB of the upper electrode 5 generated by the direct-current voltage VDC optimizes thickness of a plasma sheath.

The stabilization control device 25 previously controls the apply operation of the high-frequency power supply 16 such that the voltage VRF applied to the upper electrode 5 is lowered with a predetermined decrease rate at the time (time A5 shown in FIG. 2) before the timing when the above-stated apply of the direct-current voltage VDC by the direct-current power supply 22 is started (time A6 shown in FIG. 2). The lowering of the voltage VRF is performed until the apply of the direct-current voltage VDC is started (time A6 shown in FIG. 2). After the apply of the direct-current voltage VDC is started, the control is performed such that the value of the voltage VRF is increased with a predetermined increase rate, and when the voltage VRF reaches a predetermined value (time A8 shown in FIG. 2), the voltage VRF is held at the predetermined value.

Besides, the stabilization control device 25 controls the matching device 15 to previously execute the matching operation at the apply start time of the direct-current voltage VDC predicted from the calculated predicted impedance Zp (the matching operation between the times A6 and A8 of the impedance Zm shown by a dotted line in FIG. 2) at the time (time A4 shown in FIG. 2) before the timing when the above-stated apply of the direct-current voltage VDC is started (time A6 shown in FIG. 2). Concretely speaking, the thickness of the plasma sheath of the upper electrode 5 is calculated from a matcher position of the matching device 15 before the direct-current voltage VDC is applied, an output of the high-frequency power supply 22 and a peak-to-peak voltage VPP of the upper electrode 5. Further, a change of the thickness of the plasma sheath in accordance with the apply of the direct-current voltage VDC (namely, capacitance of the plasma sheath) is calculated, and the matching device 15 is controlled so as to previously perform the matching operation based on the calculated results. After the apply of the direct-current voltage VDC is started, the matching device 15 returns to the matching operation based on the actual impedance Z of the plasma.

As stated above, the voltage VRF applied to the upper electrode 5 from the high-frequency power supply 16 and the direct-current voltage VDC applied to the upper electrode 5 from the direct-current power supply 22 become a state kept in constant (time A8 shown in FIG. 2). Besides, the predicted impedance Zp of the plasma and the impedance Zm at the high-frequency power supply 16 side matched by the matching device 15 also become the state kept in constant. The substrate W is etched for a predetermined time under this state.

After the etching of the substrate W is finished, the decrease of the direct-current voltage VDC applied to the upper electrode 5 by the direct-current power supply 22 (namely, a termination operation of the apply of the direct-current voltage VDC) is started by the control of the stabilization control device 25 (time A11 shown in FIG. 2). The decrease of the direct-current voltage VDC is performed with a predetermined decrease rate, and finally, the apply of the direct-current voltage VDC to the upper electrode 5 by the direct-current power supply 22 is stopped (time A13 shown in FIG. 2).

The stabilization control device 25 previously controls the apply operation of the high-frequency power supply 16 such that the voltage VRF applied to the upper electrode 5 is lowered with a predetermined decrease rate at the time (time A10 shown in FIG. 2) before the timing when the above-stated termination operation of the apply of the direct-current voltage VDC by the direct-current power supply 22 is started (time A11 shown in FIG. 2). The lowering of the voltage VRF is performed until the termination operation of the apply of the direct-current voltage VDC is started (time A11 shown in FIG. 2). After the termination operation of the apply of the direct-current voltage VDC is started, the control is performed such that the value of the voltage VRF is increased with a predetermined increase rate, and when the voltage VRF reaches a predetermined value (time A13 shown in FIG. 2), then the voltage VRF is held at the predetermined value.

Besides, the stabilization control device 25 controls the matching device 15 such that the matching operation at the apply termination time of the direct-current voltage predicted from the calculated predicted impedance Zp (the matching operation between the times A11 and A13 of the impedance Zm shown by a dotted line in FIG. 2) is previously performed at the time (time A9 shown in FIG. 2) before the timing when the above-stated termination operation of the apply of the direct-current VDC is started (time A11 shown in FIG. 2). After the apply of the direct-current voltage VDC is terminated, the matching device 15 returns to the matching operation based on the actual impedance Z of the plasma.

Subsequently, a termination operation of the apply of the voltage VRF to the upper electrode 5 from the high-frequency power supply 16 is started (time A14 shown in FIG. 2) by the control of the stabilization control device 25, and the value of the voltage VRF is decreased with a predetermined decrease rate. Finally, the voltage VRF is stopped (time A16 shown in FIG. 2). The plasma in the processing chamber 2 decreases caused by the decrease of the voltage VRF, and therefore, the predicted impedance Zp of the plasma also increases. The matching device 15 matches the impedance Zm at the high-frequency power supply 16 side based on the actual impedance Z of the plasma, and therefore, the impedance Zm shows a substantially similar behavior to the predicted impedance Zp.

Finally, the supplies of the high-frequency power from the high-frequency power supply 16 and the direct-current voltage from the direct-current power supply 22 to the upper electrode 5 are stopped, and it becomes a final state (time A16 shown in FIG. 2) which is the same as the initial state (time A1 shown in FIG. 2) in which the matching device 15 is not activated. As stated above, the controls of the apply operation of the direct-current power supply 22, the apply operation of the high-frequency power supply 16, and the matching operation of the matching device 15 by the stabilization control device 25 are completed.

According to a first embodiment as stated above, it becomes possible to suppress an influence on the voltage VRF exerted by the apply operation of the direct-current voltage VDC to the minimum owing that the voltage VRF applied to the upper electrode 5 by the high-frequency power supply 16 is controlled to be previously adjusted at the timing when the apply of the direct-current voltage VDC to the upper electrode 5 by the direct-current power supply 22 is started or terminated, under the state in which the voltage VRF is applied to the upper electrode 5 by the high-frequency power supply 16 by using the stabilization control device 25. In particular, the voltage VRF applied to the upper electrode 5 is controlled to be previously lowered before the apply of the direct-current voltage VDC is started or terminated, and thereby, it becomes possible to reduce reflection energy returned to the high-frequency power supply 16 caused by a sudden change of the impedance Z of the plasma, and to prevent a lowering of the output of the high-frequency power by preventing an activation of a reflection protection circuit of the high-frequency power supply 16. Accordingly, it becomes possible to prevent that the apply operation of the high-frequency power supply 16 and the matching operation of the matching device 15 become unstable. Besides, the plasma in the processing chamber 2 is stabilized, and the plasma processing of the substrate W can be performed stably.

Besides, it is controlled such that the matching operation performed by the matching device 15 is previously adjusted at the timing when the apply of the direct-current voltage VDC to the upper electrode 5 by the direct-current power supply 22 is started or terminated by using the stabilization control device 25, and thereby, it becomes possible to correspond to the influence on the voltage VRF exerted by the apply operation of the direct-current voltage VDC in early time, and to prevent that the control of the matching device 15 becomes unstable. In particular, when the matching operation performed by the matching device 15 is previously adjusted, it is adjusted based on the calculated predicted impedance Zp of the plasma, and thereby, more appropriate correspondence for the influence exerted by the apply operation of the direct-current voltage VDC becomes possible.

Further, the stabilization control device 25 controls the high-frequency power supply 16, the matching device 15, and the direct-current power supply 22, and thereby, it becomes possible to suppress the influence on the voltage VRF exerted by the apply operation of direct-current voltage VDC to the minimum by performing the apply operation of the voltage VRF to the upper electrode 5 by the high-frequency power supply 16, the apply operation of the direct-current voltage VDC to the upper electrode 5 by the direct-current power supply 22, and the matching operation by the matching device 15 at optimal timings.

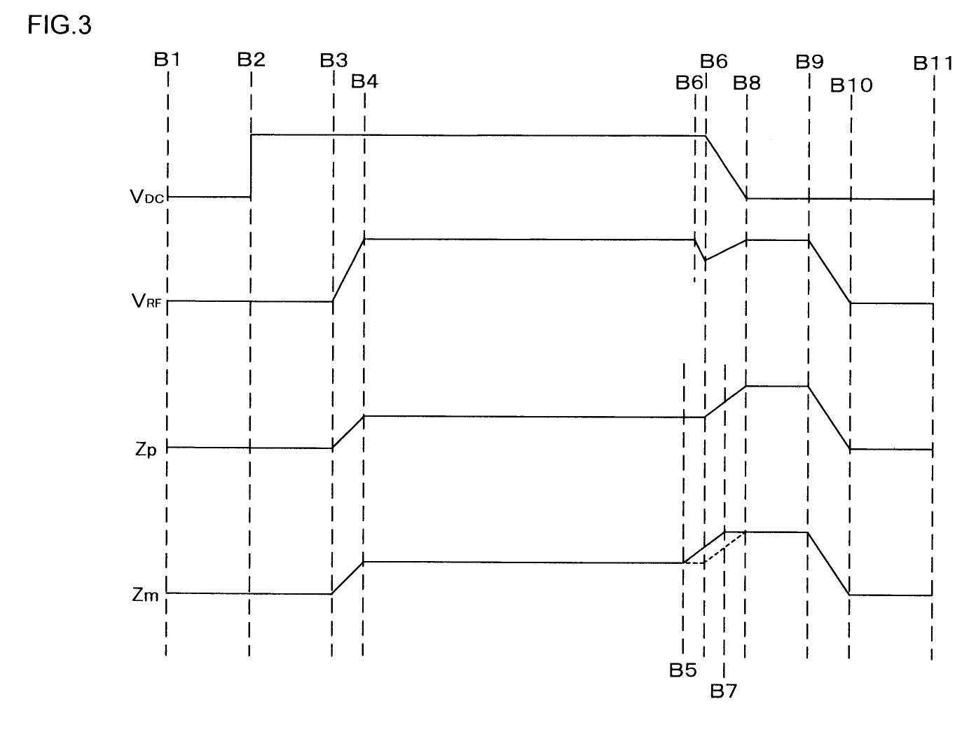

As a second embodiment of the present invention, the high-frequency power supply 16 may be controlled such that the apply operation is performed while considering an influence on the plasma exerted by the direct-current voltage applied to the upper electrode 5, when the apply of the high-frequency power to the upper electrode 5 by the high-frequency power supply 16 is started or terminated under the state in which the direct-current voltage is applied to the upper electrode 5 by the direct-current power supply 22, as shown in FIG. 3.

FIG. 3 is a timing chart showing the apply operation of the direct-current power supply 22, the apply operation of the high-frequency power supply 16, and the matching operation of the matching device 15 controlled by the stabilization control device 25 at the time of plasma etching in the second embodiment of the present invention. In FIG. 3, a horizontal axis direction shows a time flow, and a vertical axis direction respectively shows changes of the value VDC of the direct-current voltage applied to the upper electrode 5 by the direct-current power supply 22, the voltage value VRF of the high-frequency power applied to the upper electrode 5 by the high-frequency power supply 16, the value Zp of the predicted impedance of the plasma in the processing space K, and the value Zm of the impedance at the high-frequency power supply 16 side to be matched with the actual impedance Z of the plasma by the matching device 15.

At an initial state (time B1 shown in FIG. 3), the high-frequency power from the high-frequency power supply 16 and the direct-current voltage from the direct-current power supply 22 are not supplied to the upper electrode 5. Namely, both values of the voltage VRF applied to the upper electrode 5 by the high-frequency power supply 16 and the direct-current voltage VDC applied to the upper electrode 5 by the direct-current power supply 22 are zero. Consequently, the plasma is not generated in the processing chamber 2 at this time B1, and therefore, the predicted impedance Zp of the plasma is not shown. Besides, the matching device 15 controlling the impedance Zm at the high-frequency power supply 16 side is not activated.

As shown in FIG. 3, the direct-current voltage VDC is applied to the upper electrode 5 from the direct-current power supply 22 by the control of the stabilization control device 25 (time B2 shown in FIG. 3). The direct-current voltage VDC is held at a predetermined value.

The apply of the voltage VRF to the upper electrode 5 from the high-frequency power supply 16 is started by the control of the stabilization control device 25 (time B3 shown in FIG. 3), and the value of the voltage VRF is increased with a predetermined increase rate. When the voltage VRF reaches a predetermined value (time B4 shown in FIG. 3), then it is held at the predetermined value. The plasma is generated and increased from the processing gas in the processing chamber 2 by the apply of the voltage VRF, and therefore, the predicted impedance Zp of the plasma is lowered, then the predicted impedance Zp becomes constant when the voltage VRF becomes constant. In the second embodiment, the apply of the voltage VRF is started under a state in which the direct-current voltage VDC is applied to the upper electrode 5 in advance, and the self bias voltage VSB is increased. Accordingly, a growth of the plasma after the apply of the voltage VRF is started is early, and the plasma sheath becomes thick from an ignition time. Accordingly, the calculated predicted impedance Zp of the plasma decreases rapidly compared to the case of the first embodiment (between A6 and A8 shown in FIG. 2) as shown in FIG. 3, and the voltage VRF reaches the predetermined value earlier than the case of the first embodiment (time B4 shown in FIG. 3).

The stabilization control device 25 controls the matching device 15 such that the matching operation is performed while considering a point in which the growth of the plasma becomes early by performing the apply of the direct-current voltage VDC in advance based on the calculated predicted impedance Zp as stated above, and a point in which the plasma sheath becomes thicker compared to the case when the direct-current voltage VDC is not applied under the state in which the plasma is stable.

As stated above, the voltage VRF applied to the upper electrode 5 from the high-frequency power supply 16 and the direct-current voltage VDC applied to the upper electrode 5 from the direct-current voltage 22 become a state kept in constant (time B4 shown in FIG. 3). Besides, the predicted impedance Zp of the plasma and the impedance Zm at the high-frequency power supply 16 side matched by the matching device 15 also become a state kept in constant. The etching of the substrate W is performed for predetermined time under this state. After the etching is finished, a stop of the apply of the direct-current voltage VDC to the upper electrode 5 by the direct-current power supply 22, a stop of the apply of the voltage VRF to the upper electrode 5 by the high-frequency power supply 16 are sequentially performed as same as the first embodiment shown in FIG. 2 (times B5 to B10 shown in FIG. 3) by the control of the stabilization control device 25. Finally, supplies of the high-frequency power from the high-frequency power supply 16 and the direct-current voltage from the direct-current power supply 22 to the upper electrode 5 are stopped, and it becomes a final state (time B11 shown in FIG. 3) which is the same as the initial state (time B1 shown in FIG. 3) in which the matching device 15 is not activated.

According to the second embodiment as stated above, it becomes possible to perform the apply operation of the high-frequency power supply 16 and the matching operation of the matching device 15 more appropriately than before by controlling the matching device 15 using the stabilization control device 25 such that the matching operation while considering the influence on the plasma caused by the direct-current voltage VDC applied to the upper electrode 5 is performed when the apply of the voltage VRF to the upper electrode 5 by the high-frequency power supply 16 is started or terminated under the state in which the direct-current voltage VDC is applied to the upper electrode 5 by the direct-current power supply 22. Accordingly, it becomes possible to prevent that the apply operation of the high-frequency power supply 16 and the matching operation of the matching device 15 become unstable. Besides, in the second embodiment, the similar effect to the first embodiment can be obtained.

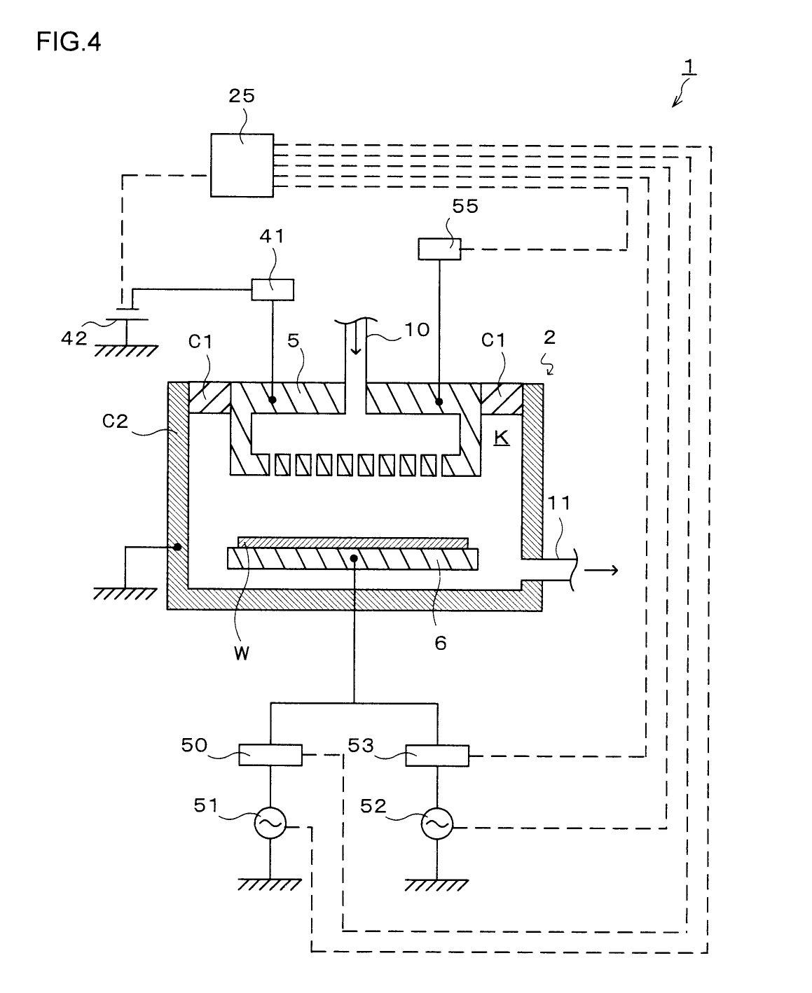

As a third embodiment of the present invention, only a direct-current power supply 42 may be connected to the upper electrode 5 via a low-pass filter 41, and high-frequency power supplies 51, 52 supplying high-frequency powers having two different frequencies may be connected to the lower electrode 6, as shown in FIG. 4. The high-frequency power supply 51 is connected to the lower electrode 6 via a matching device 50, and the high-frequency power supply 52 is connected to the lower electrode 6 via a matching device 53. The frequencies of the high-frequency powers supplied by the high-frequency power supplies 51, 52 may be, for example, 100 MHz, 3.2 MHz, respectively. FIG. 4 is a configuration diagram of the plasma etching apparatus 1 as a plasma processing apparatus according to the third embodiment of the present invention.

As shown in FIG. 4, a measuring device 55 capable of measuring the value of the voltage VRF is connected to the upper electrode 5. The high-frequency power supplies 51, 52, the matching devices 50, 53, the direct-current power supply 42 and the measuring device 55 are connected to the stabilization control device 25. This stabilization control device 25 respectively controls respective apply operations of the high-frequency powers to the lower electrode 6 by the high-frequency power supplies 51, 52, matching operations of impedance between the high-frequency power supplies 51, 52 and the plasma in the processing space K by the matching devices 50, 53, and an apply operation of a direct-current voltage to the upper electrode 5 by the direct-current power supply 42, and it becomes possible to stabilize a plasma processing of the substrate W.

The measuring device 55 measuring the self bias voltage VSB of the upper electrode 5 is connected to the stabilization control device 25. Here, the value Zp of the predicted impedance of the plasma is calculated based on the self bias voltage VSB measured by the measuring device 55 when the direct-current voltage apply to the upper electrode 5 is performed after the high-frequency power apply to the lower electrode 6 as in the first embodiment. Besides, the stabilization control device 25 controls the high-frequency power supplies 51, 52, the matching devices 50, 53, and the direct-current power supply 42 as same as the first embodiment.

According to the third embodiment as stated above, it becomes possible to prevent that the respective apply operations of the high-frequency power supplies 51, 52 and the matching operations of the matching devices 50, 53 become unstable by controlling such that voltages VRF1, VRF2 applied to the lower electrode 6 are respectively adjusted previously at a timing when the apply of the direct-current voltage VDC is started or terminated by using the stabilization control device 25, even when the direct-current voltage VDC and the voltage VRF are applied to the different electrodes (namely, the direct-current voltage VDC is applied to the upper electrode 5, and the voltages VRF1, VRF2 are applied to the lower electrode 6). Besides, in the third embodiment, the effect of the first embodiment can similarly be obtained.

Besides, the stabilization control device 25 controls the matching devices 50, 53 such that the matching operations while considering the influence on the plasma caused by the direct-current voltage VDC applied to the upper electrode 5 is to be performed when the applies of the respective voltages VRF1, VRF2 to the lower electrode 6 by the high-frequency power supplies 51, 52 are started or terminated under the state in which the direct-current voltage VDC is applied to the upper electrode 5 by the direct-current power supply 42, and then, the effect similar to the second embodiment can be obtained.

Hereinabove, the preferred embodiments of the present invention have been explained with reference to the attached drawings, but the present invention is not limited to such examples. It is clear that a person skilled in the art can devise various variation examples and modification examples within the scope of technical ideas described in the claims, and it is understood that such changes and modifications also belong to the technical scope of the present invention as a matter of course.

In the above-described embodiments, the case is explained where the upper electrode 5 and the lower electrode 6 are arranged to face in the processing chamber 2, but the number of the electrodes arranged in the processing chamber 2 may be one, or three or more. Besides, the one or more electrodes arranged in the processing chamber 2 may have an arbitrary configuration.

In the above-described embodiments, the case is explained where the stabilization control device 25 controlling the high-frequency power supply 16 (51, 52) and the matching device 15 (50, 53) also controls the apply operation of the direct-current power supply 22 (42), and previously adjusts the voltage VRF (VRF1, VRF2) applied to the upper electrode 5 (lower electrode 6), or the matching operation of the matching device 15 (50, 53) at the timing when the apply of the direct-current voltage VDC by the direct-current power supply 22 (42) is started or terminated. However, the stabilization control device 25 does not have to control the direct-current power supply 22 (42). In that case, the stabilization control device 25 may previously have information of the timing when the apply of the direct-current voltage VDC to the upper electrode 5 by the direct-current power supply 22 (42) is started or terminated, or information of the direct-current voltage applied to the electrode by the direct-current power supply, and thereby, the voltage VRF (VRF1, VRF2) applied to the upper electrode 5 (lower electrode 6) or the matching operation of the matching device 15 (50, 53) may previously be adjusted.

In the above-described embodiments, the cases are explained where the high-frequency power and the direct-current voltage are applied to the upper electrode 5 and the high-frequency power is applied to the lower electrode 6 as shown in FIG. 1, and where only the direct-current voltage is applied to the upper electrode 5 and the two different high-frequency powers are applied to the lower electrode 6 as shown in FIG. 4, but one or more high-frequency powers may be applied to either of the electrodes. Besides, one or more direct-current voltages may be applied to either of the electrodes.

In the above-described embodiments, the case is explained where the previous matching operation of the matching device 15 by the control of the stabilization control device 25 (time A4 shown in FIG. 2) is started before the previous apply operation of the high-frequency power supply 16 by the control of the stabilization control device 25 (time A5 shown in FIG. 2), but the start sequence of both operations may be reversed, or they may be started simultaneously.

In the above-described embodiments, the case is explained where the frequencies of the high-frequency powers supplied by the high-frequency power supplies 16, 31, 51, 52 respectively are 60 MHz, 2 MHz, 100 MHz, and 3.2 MHz, but the frequency of the high-frequency power supplied by each high-frequency power supply may be an arbitrary frequency.

The present invention is useful for, for example, a plasma processing apparatus for a substrate, and particularly useful for a plasma etching apparatus performing a plasma etching of a substrate.

What is claimed is:

1. A plasma processing apparatus having one or more electrodes in a processing chamber, generating plasma in the processing chamber by supplying at least any of the electrodes with a high-frequency power to process a substrate, comprising:
a high-frequency power supply applying the high-frequency power to at least any of the one or more electrodes;
a direct-current power supply applying a direct-current voltage to at least any of the one or more electrodes;
a matching device provided between the electrode to which the high-frequency power is applied and said high-frequency power supply; and
a control device controlling said high-frequency power supply such that the high-frequency power applied to the electrode is previously adjusted at a timing when the apply of the direct-current voltage to the electrode by said direct-current power supply is started or terminated, under a state in which the high-frequency power is applied to the electrode by said high-frequency power supply.

2. The plasma processing apparatus according to claim 1,
wherein the high-frequency power applied to the electrode is adjusted to be lowered when the high-frequency power applied to the electrode by said high-frequency power supply is previously adjusted.

3. The plasma processing apparatus according to claim 1,
wherein said control device controls said matching device such that a matching operation is previously adjusted at a timing when the apply of the direct-current voltage to the electrode by said direct-current power supply is started or terminated under the state in which the high-frequency power is applied to the electrode by said high-frequency power supply.

4. The plasma processing apparatus according to claim 3,
wherein the matching operation of the matching device is adjusted based on a prediction of a change of the plasma in the processing chamber when the matching operation of the matching device is previously adjusted.

5. The plasma processing apparatus according to claim 1,
wherein said control device previously has information of a timing when the apply of the direct-current voltage to the electrode by said direct-current power supply is started or terminated, or information of the direct-current voltage applied to the electrode by said direct-current power supply.

6. The plasma processing apparatus according to claim 1,
wherein said control device controls said direct-current power supply such that the apply of the direct-current voltage to the electrode is started or terminated.

7. The plasma processing apparatus according to claim 1,
wherein said control device controls said matching device such that the matching operation is to be performed while considering an influence on the plasma caused by the direct-current voltage applied to the electrode when the apply of the high-frequency power to the electrode by said high-frequency power supply is started or terminated under a state in which the direct-current voltage is applied to the electrode by said direct-current power supply.

8. A plasma processing method, generating plasma in a processing chamber by supplying at lest any of one or more electrodes provided in the processing chamber with a high-frequency power to process a substrate, comprising:
applying the high-frequency power to at least any of the one or more electrodes;
applying a direct-current voltage to at least any of the one or more electrodes; and
previously adjusting the high-frequency power applied to the electrode at a timing when the apply of the direct-current voltage is started or terminated under a state in which the high-frequency power is applied to the electrode.

9. The plasma processing method according to claim 8,
wherein the high-frequency power applied to the electrode is adjusted to be lowered when the high-frequency power applied to the electrode is previously adjusted.

10. The plasma processing method according to claim 8,
wherein the apply of the high-frequency power to the electrode is performed while matching impedance between the plasma in the processing chamber and the high-frequency power supply supplying the high-frequency power, and
wherein the matching of the impedance is previously adjusted at a timing when the apply of the direct-current voltage to the electrode is started or terminated under the state in which the high-frequency power is applied to the electrode.

11. The plasma processing method according to claim 10,
wherein the matching of the impedance is adjusted based on a prediction of a change of the plasma in the processing chamber when the matching of the impedance is previously adjusted.

12. The plasma processing method according to claim 10,
wherein the matching of the impedance is performed while considering an influence on the plasma caused by the direct-current voltage applied to the electrode when the apply of the high-frequency power to the electrode is started or terminated under a state in which the direct-current voltage is applied to the electrode.
